(19) United States
(12) Patent Application Publication
(10) Pub. No.: US 2023/0325764 A1
(43) Pub. Date: Oct. 12, 2023

(54) OPTIMIZATION OF MAXIMUM QUANTITY ALLOWED PER LARGE ORDER

(71) Applicant: Schneider Electric USA, Inc., Andover, MA (US)

(72) Inventors: Aditya Pahuja, Varanasi (IN); Vidya Shree Suresh, Coimbatore (IN); Gattupalli Sai Kumar, Hyderabad (IN); Bokka Rama Reddy, Hyderabad (IN); Sikha Teja, Guntur (IN); Madhu Hasadurga-Rajanna, Bangalore (IN)

(73) Assignee: Schneider Electric USA, Inc., Andover, MA (US)

(21) Appl. No.: 17/718,578

(22) Filed: Apr. 12, 2022

(51) Int. Cl. G06Q 10/08; G06Q 10/04

(52) U.S. Cl. CPC G06Q 10/087; G06Q 10/04

(57) ABSTRACT

A method including simulating future stock data and future order data of an item supplied by a distribution center, optimizing, based on the simulated future stock data and the simulated future order data, a maximum quantity of the item allowed to be fulfilled by the distribution center over time, receiving notification of an order request by a customer for a requested quantity of the item supplied by a distribution center for a target delivery date, determining whether the requested quantity exceeds the maximum quantity that is optimized for the target delivery date, upon determining that the requested quantity exceeds the maximum quantity that is optimized for the target delivery date, calculating an extended delivery plan for fulfilling the order request using the simulated fulfillment, and adjusting an action for fulfilling the order request based on the extended delivery plan.

### TECHNICAL FIELD

The present disclosure relates to optimization for industrial control, and more particularly, to optimization of maximum quantity allowed per customer large order for fulfillment of online line store orders.

### BACKGROUND

In a supply chain, the demand of customer can vary from single unit of the products to a substantially high number. An unforeseeable order of huge volume for a particular item, either from an old customer or a new customer can drain stock for that item, which in turn can cause unavailability of stock of that item for multiple small orders, increase in back orders for the item, and reduce customer satisfaction.

A distribution center can receive requests for orders (e.g., via an online store) from many customers and strive to replenish stock to have enough stock available for the items it sells. Stock can be replenished for many different items from many different factories or distribution centers. Items can be transported for replenishment of stock or fulfillment of orders by ship when time allows. Otherwise, items can be transported by air, albeit at a much increased cost. This cost may be absorbed by the distribution center, since it is a function of the distribution center's own logistics, or may be passed on to the customer, causing a rise in cost for the item and possible customer dissatisfaction. When an item cannot be replenished in time for fulfillment of an order, fulfillment of the order is impacted, which can lead to customer dissatisfaction and/or attrition.

There may be a temptation to avoid customer dissatisfaction by increasing quantities of available stock, however this may still not protect the distribution center form large surges in demand and negatively impacts an efficiency goal, namely maximum projected stock on-hand utilization. When too much stock is kept on-hand, storage efficiency is diminished

While conventional methods and systems have generally been considered satisfactory for their intended purpose, there is still a need in the art for a control system of an order fulfillment center to control how order requests are fulfilled for increasing or maximizing efficiency and satisfaction and decreasing or minimizing cost.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a method of optimizing maximum quantity allowed per customer large order for order fulfillment by a distribution center. The method includes simulating future stock data for an item supplied by a distribution center based on a comparison of a recent consumption pattern of stock relative to a consumption pattern of historical stock data, simulating future order data of the item for the distribution center based on historical order data and optimizing, based on the simulated future stock data and the simulated future order data, a maximum quantity of the item allowed to be fulfilled by the distribution center. The method further includes receiving notification of an order request by a customer for a requested quantity of the item supplied by a distribution center for a target delivery date and determining whether the requested quantity exceeds the maximum quantity that is optimized for the target delivery date. Upon determining that the requested quantity exceeds the maximum quantity that is optimized for the target delivery date, an extended delivery plan is calculated for fulfilling the order request using the simulated fulfillment. The extended delivery plan includes at least one delivery performed based on an extended delivery timeframe that is in excess of a standard delivery timeframe used by default for order requests of the item that request a compliant quantity of the item that would not exceed the maximum quantity when optimized for the standard delivery timeframe. The method further includes adjusting an action for fulfilling the order request based on the extended delivery plan.

In one or more embodiments, the comparison can use a consumption pattern associated with a selected portion of the historical stock data that corresponds to a first cycle defined between replenishment points that most closely resembles a second cycle of the recent consumption pattern.

In one or more embodiments, the consumption pattern associated with the selected portion of the historical stock data can be based on average daily unit (ADU).

In one or more embodiments, the ADU can be adjusted for usage of safety stock before selecting the selected portion of the historical stock data.

In one or more embodiments, simulating future order data can include generating simulations of multiple ordering scenarios for respective customers associated with historical order data for the item and selecting a most probable scenario from the generated simulations of the multiple ordering scenarios based on a comparison of one or more parameters of stocking of the generated simulations to one or more calculated parameters of stocking for the item, historical changes in calculated parameters of stocking for the item, and/or trends in the calculated parameters of stocking for the item.

In one or more embodiments, the calculated parameters of stocking can include at least one of average daily unit (ADU), average demand interval (ADI), and statistics related to safety stock.

In one or more embodiments, the generated simulations can be generated using random sampling of the historical order data.

In one or more embodiments, the most probable scenario can be selected using impact data about orders, wherein the impact data can provide information about orders that were impacted by nonfulfillment of a complete order by a requested date as requested by the order request.

In one or more embodiments, the method can further include receiving the historical order data for the distribution center, the historical order data specifying a plurality of historical orders from a plurality of customers for the item over time and receiving the historical stock data for the item and the distribution center, the historical stock data specifying historical stock status and parameters of stocking and replenishing stock of the item over time.

In one or more embodiments, the historical order data and the historical stock data received can be continually updated. The method can further include updating the simulation of the future order data and the optimization of the maximum quantity as the historical order data and the historical stock data is updated.

In one or more embodiments, optimizing the maximum quantity can include applying a root finding function and/or optimization technique.

In one or more embodiments, the historical stock status can include an amount of a respective items available in stock at intervals of time, the parameters of stocking include safety stock that indicates an amount of the respective items intended to be held in stock at all times that is not available for routine fulfillment of orders, average daily unit that indicates an amount of the items ordered for the respective items for a predetermined interval of time, and/or backorders for the respective items that indicates an amount of the respective items ordered while not currently available in stock and still available for order and/or the parameters of replenishing stock include a reorder point that indicates an amount of available stock of the respective items at which the stock needs to be replenished for the respective items, a lead time that indicates latency between receipt of an order request for and delivery of the respective items, and/or respective items in transit that identifies an amount of the respective items that are in transit for replenishing stock of the respective items.

In one or more embodiments, the parameters of replenishing stock can include parameters of replenishing stock for respective distribution centers of a plurality of distribution centers and for respective items of a plurality of items, and wherein generating the simulation of the fulfillment can apply methods of processing big data.

In accordance with aspects of the disclosure, a computer system is provided that performs the disclosed method. In accordance with further aspects of the disclosure a non-transitory computer readable storage medium and one or more computer programs embedded therein is provided, which when executed by a computer system, cause the computer system to perform the disclosed method.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 illustrates a block diagram of an example online ordering system having an order fulfillment manager, in accordance with an aspect of the disclosure;

FIG. 2 illustrates an example flowchart showing an example method of optimizing maximum quantity allowed per large order for order fulfillment by an distribution center, in accordance with an aspect of the disclosure;

FIG. 3 illustrates an example flowchart showing an example method performed by a delivery engine of the online ordering system of FIG. 1, in accordance with an aspect of the disclosure;

FIG. 4 illustrates an example computing system that could be used to implement the order fulfillment manager and an online store server shown in FIG. 1, in accordance with an aspect of the disclosure; and

FIG. 5 illustrates an example computing environment for implementation of an online ordering system, in accordance with an aspect of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

An order fulfillment manager is disclosed that applies an artificial intelligence (AI) based model that uses a simulation of future order data and future stock data for determining an optimal maximum quantity (Qmax) of various finished items allowed to be ordered from an online store per finished item per customer per day. The online store is an entity that receives order requests for an item (e.g., a finished item). The item is available from various items sold by the online store. The order requests can be made by customers e.g., by accessing a website or calling into a call center hosted by a server of the online store.

In an example scenario, a customer A1 places two orders on the same day of item 11, with Order 1 for a first quantity qty1 (qty1<Qmax) and Order 2 for a second quantity qty2 (qty2<Qmax). Order 1 of qty1 is handled with a standard delivery route, however Order 2 can only proceed with the standard delivery route if the condition ((qty1+qty2)<Qmax) is satisfied, otherwise, to avoid exceeding Qmax, a delayed delivery is used for Order 2.

Qmax is updated over time as the simulation is updated based on updates to data fed to the simulation. When an order request is received by the online store for a quantity of an item and a target delivery date is set for the order, the order fulfillment manager is notified. The target date can be a date requested by the order request or a default date assigned by the online store. The default date is based on a standard delivery timeframe (used by default) for orders of the item from a distribution center that supplies the item that do not exceed the Qmax for the distribution center. The order fulfillment manager compares the quantity of the item requested to Qmax, which is optimized for that item using Al for the target delivery date. Upon determining that the requested quantity exceeds the Qmax for the target delivery date, a rule based model is used to calculate an extended delivery plan for fulfilling the order request. The extended delivery plan includes at least one delivery performed based on an extended delivery timeframe that is in excess of the default date. The extended delivery plan is delivered to an order fulfillment engine of the online store and an action is caused for fulfilling the order request based on the extended delivery plan.

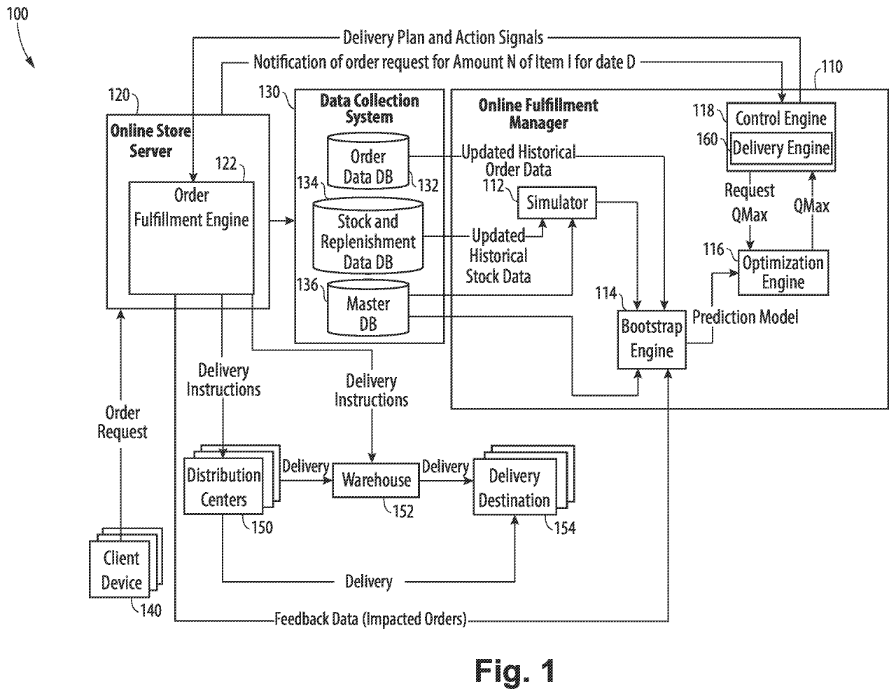

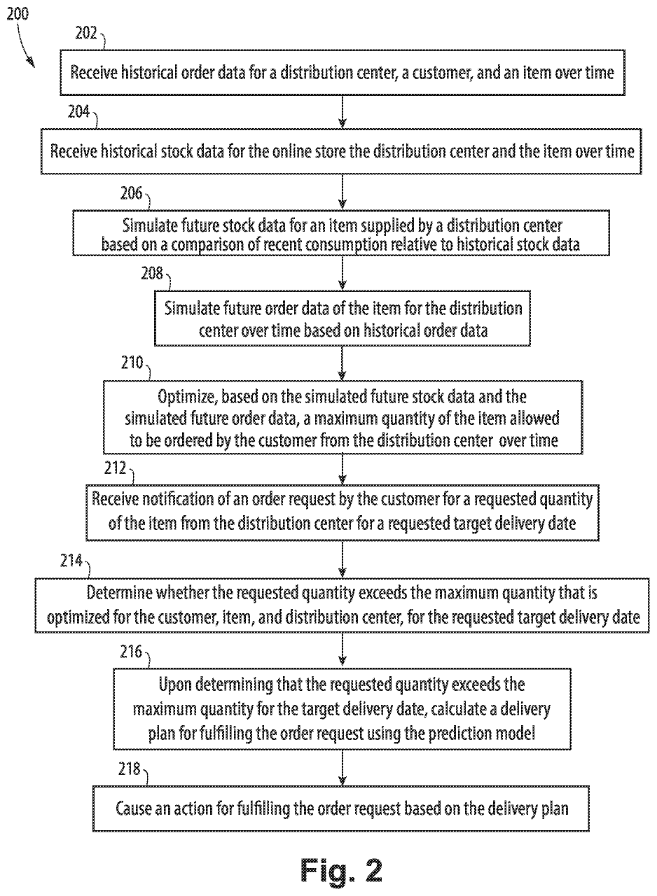

With reference now to the drawings, for purposes of explanation and illustration, and not limitation, a block diagram of an exemplary embodiment of an online ordering system in accordance with the disclosure is shown in FIG. 1, wherein the online ordering system is designated generally by reference character 100. Methods associated with optimizing fulfillment of multiple orders for items from the distribution center within the online ordering system 100 in accordance with the disclosure, or aspects thereof, are provided in FIGS. 2-5, as will be described.

With reference now to FIG. 1, online ordering system 100 includes an order fulfillment manager 110, an online store server 120, and a data collection system 130, each of which are computing systems having a memory that stores programmable instructions and a processing device for executing the programmable instructions. Online store server 120 receives multiple order requests for various items from one or more sources, such as a client device 140. Fulfillment of the orders is managed by order fulfillment engine 122, such as for sending delivery instructions for scheduling deliveries from multiple distribution centers (DCs) 150 (without limitation to a particular number of DCs) to one or more warehouses 152 of the online store and from the DCs 150 or warehouse 152 to an appropriate delivery destination 154 by a target date. Data collection system 130 can track the order requests received by online store server and store historical data about the order requests in order data database (DB) 132. Data stored for each order request can include, for example, identity of the customer that made the order, the item ordered, an amount of the item ordered, a delivery destination, and optionally a target date for delivery to the delivery destination. If a target date is not specified, a default is used for the target date. It is noted, data collection system 130 can be configured using a data lake and can be incorporated into a big data architecture.

Data collection system 130 can further track data about stocking items sold by the online store in the warehouse(s) 152 and replenishment of the items in the warehouse(s)'s stock as historical stock and replenishment data DB 134. The historical stock and replenishment data (also referred to concisely as historical stock data) can include stock status as well as parameters of stocking and replenishing stock (also referred to as parameters of stocking) of the item over time. The stock status is a history of an amount of respective items available in stock at time intervals. Time intervals can be regular intervals, or can correlated to an event, such as the amount of a particular item exceeding or below a threshold.

The parameters of stocking can include safety stock, average daily unit (ADU) for the respective items (wherein ADU is also referred to as average daily consumption rate), and/or backorders for the respective items. Safety stock for an item indicates an amount of the item intended to be held in stock at all times that is not available for routine fulfillment of orders. The historical stock data can include an amount of safety stock available at respective time intervals. ADU for an item indicates an amount of the items ordered for predetermined time intervals. A backorder for an item indicates an amount of the item that was ordered by one or more order requests, but is not currently available in stock and was still available for order at the time of the order requests.

The parameters of stocking include a reorder point, a lead time, ADU, and items in transit. The reorder point for an item indicates an amount of available stock of the item at which the stock needs to be replenished for the item. Lead time for an item indicates latency between receipt of an order request for the item and delivery of the item. Item in transit for an item identifies an amount of the item that is in transit for replenishing stock of the item.

A master database 136 can store master data needed for transactions, including but not limited to, parameters such as unique identification (ID) of an item, unique ID of DCs and warehouses that offer item(s), business unit that produces/assembles the items, product family to which the item(s) belong, product line to which the item(s) belong, velocity of the item (meaning how frequently the item is bought (e.g., whether it is a fast mover (F), medium mover (M), rare mover (R) and stopped (S)), stocking policy of the item (meaning whether the DC 150 uses a made to stock (MTS) policy to stock an item based on prediction of customer demand or uses a made to order (MTO) policy to request production of the item by a factory once an order is received, minimum order quantity for the item, lot size information for the item, exceptions (if any), default lead time, etc. Master data can be aggregated from multiple data centers and can include calculated parameters. The master data may or may not be similar to corresponding data stored in order data DB 132 and stock and/or replenishment data DB 134). Examples of exceptions include newly introduced items, items marked to be stopped (meaning to be discontinued), items kept only for servicing old items, etc.

Calculated parameters stored for each item and DC include, for example, ADU, ADI, and statistics of (e.g., mean or average) safety stock (SS) (e.g., stored as master ADU, master ADI, master mean (or AVG) SS, respectively). The master data is updated, such as on a daily, weekly, or monthly basis, e.g., based on how frequent the corresponding data point is updated, whether updated manually or automatically. The master data can further include a history that shows changes over time (e.g., daily, weekly, monthly) in respective parameters, such as master ADU and master ADI. The history can show changes in time or trends for the calculated parameters.

Restrictions can be applied as desired, such as by allowing Qmax to be applied only on items to which a MTS stocking policy is applied.

Order fulfillment engine 110 includes a simulator 112, a bootstrap prediction engine 114, an optimization engine 116, and a control engine 118. Bootstrap prediction engine 114 receives historical order data and simulator 112 receives historical stock data for each respective item offered for sale by the online store. The historical order data received provides a view of request orders over time from a selected point in time, and the historical stock data provides a view of stock status from a second selected point in time (which can be the same or different than the first selected point in time) and the parameters used for stocking and replenishing the item since the second point in time. Each type of data included in the historical order data and historical stock data can be provided at selected intervals (e.g., per day, per week, etc.), and different selected intervals can be used for the different types of data. Both bootstrap prediction engine 114 and simulator 112 receive master data.

Bootstrap prediction engine 114 includes a first simulator configured to simulate future order data for each of the items over time based on the historical order data. The future order data simulation can be for a first prediction date, wherein the first prediction date can be the current data (which is futuristic relative to the historical data) or a date that is further into the future. This simulation does not take into consideration how the simulated stock data affects the simulated future order data.

Simulator 112 includes a second simulator configured to simulate future stock data for each of the items supplied by a distribution center over time based on a comparison of consumption and replenishment of the item indicated by the historical stock data (including the historical safety stock and the parameters of stocking (e.g., historical unavailability of stock and historical ADU, etc.)) to recent consumption, e.g., as indicated by master data. The future stock data simulation can be over time until a second prediction date, wherein the second prediction date can be the current data (which is futuristic relative to the historical data) or a date that is further into the future. The first and second prediction dates can be the same or different dates.

The process performed by simulator 112 is as follows:
1. One or more cycles are identified in historical stock data for a given item (meaning a finished item) by a distribution center. A cycle is defined, for example and without limitation, as a time period between two replenishment points when fresh stock is added to inventory. For example, if fresh stock is added on Jan. 1, 2022 and then again on Jan. 21, 2022, the cycle starts on Jan. 1, 2022 and ends on Jan. 21, 2022.
2. The ADU of the historical stock data can be adjusted to account for usage of safety stock to fulfill customer demand.
3. Select a cycle from the cycles identified in the historical stock data that has a consumption pattern based on its ADU which matches (meaning is most similar to or is within a predetermined threshold of) the master ADU (stored in master DB 136).

Future stock is predicted, e.g., as a function of master ADU and master mean (or AVG) SS Once calculated, the simulated future stock can be used by optimization engine 116.

In operation, bootstrapping engine 114 is configured to receive historical order data from order data DB 132, the future stock simulation from simulator 112, and master data from master DB 136 (namely unique item ID, unique DC ID). Accessing historical order data for identified customers of an identified item from an identified distribution center, bootstrap engine 114 is configured to generate a large number of simulations of future order data, e.g., on the order of thousands or millions of scenarios. The future order data simulation is performed via random sampling of the accessed data. In an example, item A1 historically has been ordered by five different customers. Bootstrap engine 114 is configured to generate simulations of ordering scenarios (e.g., one million scenarios) for each customer for item A1 and the distribution center, totaling five million simulated ordering scenarios for item A1, in this example. The future stock data simulation is not taken into account for the future order data simulation.

The objective is to select one most plausible scenarios from the one million simulated ordering scenarios for the identified item. Simulator 112 simulates future fulfillment of the order by applying one or more parameters of stocking, such as historical ADU, normal demand interval (also referred to as average demand interval (ADI)), etc., to select the most plausible scenario from the simulated ordering scenarios. A buffer is kept to accommodate a decrease or increase in demand in the parameters(s) of stocking. For example, the buffer can store values for a percentage increase in ADU (e.g., +10%) and a percentage decrease (e.g., −10%) in ADU.

The following example illustrates that one or more filters can be applied to the simulated ordering scenarios determined by bootstrapping engine 114 for each of the customers of the item to determine probable candidate simulated scenarios that match the calculated parameters of stocking in the master data, such as benchmark master ADU and master ADI. The benchmarks can further include changes and/or trends in master ADU and master ADI. In this example, a most plausible scenario is sought for a particular customer and item having ADU=1.2 units and ADI=10. When searching for a most plausible future scenario from a million simulations for the customer and item, a filter can be used to filter all simulated scenarios that match, e.g., have an ADU between 1.18 to 1.32 and an ADI between 9 and 11. Application of the filter to the simulations (e.g., a million simulations) for the customer and item can result in a subset of the simulations matching the historical stock data and thus being deemed probable candidates.

The selection process can then be fine-tuned to select the most plausible scenario from the probable candidates using hit data from feedback data received by the bootstrap engine 114. The feedback data includes data about impacted orders that were impacted by an extended delivery plan for that particular order or a different order such that the impacted order was not completely fulfilled by the order's target date. The hit rate is a number of times the order quantity exceeds a corresponding Qmax. The hit rate can be correlated linearly to the range upon which ADU and ADI were filtered, with the low end of each range corresponding to a 0% hit rate, and the high end of each range corresponding to 2% hit rate. A probable candidate ordering scenario is selected that has an ADU and ADI that is closest to the ADU and ADI that correspond to the hit rate.

To illustrate, in an example, the hit rate is low, for example 0.5%. Due to the low hit rate, a probable candidate ordering scenario is selected that has ADU and ADI that are on the low end of the range at which they were filtered (e.g., having an ADU closest to 1.18 and an ADI closest to 9). In this way the most probable scenario for each customer is selected per day for a next n days until the first prediction date. The combination of the selected ordering scenarios provides a future order data simulation for the next n days for each customer. This future order data simulation is provided to optimization engine 116.

Optimization engine 116 optimizes a Qmax for respective one or more items offered for sale by the online store that are allowed to be fulfilled by the distribution center over time based on the simulation of stock orders for the one or more items. A Qmax can be provided for each item at one or more current and/or future time intervals. Qmax is obtained using an optimization technique, such as particle swarm optimization (PSO), evolutionary methods (e.g., ant colony optimization, differential evolution, etc.), iterative methods (e.g., Newton-Raphson, etc.), and Brent's method, etc. Qmax is optimized to maximally fulfill as many simulated orders as possible, minimize simulated impacted orders, and maximize consumption of simulated available stock (which is simulated by simulator 112) to avoid accumulation of excess stock. Qmax can further be optimized to refrain from exceeding impact requirements that can be set by an administrator. The optimization technique uses an objective function.

Here, the objective function is a function of candidate Qmax as well as current and/or future time intervals and resultant measurements of impact (e.g., number of hits) due to the candidate Qmax. When Qmax is applied in real time, due to optimization of the objective function, utilization of stock can be increased or maximized while impact can be reduced or minimized. Since the objective function is based on simulations rather than on strictly historical data, order fulfillment manager 110 provides a robust solution for predicting the need to take action to accommodate for future uncertainty. Robustness of the objective function can be increased by empirically deriving, by systematical experimentation and adjustment, different parameters and coefficients of the objective function, as well as mixing and matching different variables. Some examples of variables include future stock (also referred to as on hand inventory (OHI)) and number of orders affected and unaffected. Additionally, robustness has been shown experimentally by applying a function to the variables, such as raising the variables to different powers, changing the coefficient, using ADU and ADI themselves as the variables, maximizing the objective function (Instead of minimizing), etc.

Control engine 118 receives notification when order requests are received. The order requests specify an amount N of an item I that is being ordered for delivery by a target date D. If the target date D is not specified in the order request, a default target date is used. The default target date can be included in the notification by the online store server 120 or can be inserted by control engine 118. Control engine 118 obtains a Qmax from optimization engine 116 for the item and the target delivery date.

Upon determining that the requested quantity does not exceed Qmax, control engine 110 does not provide any delivery plan, and online store server 120 handles fulfillment of the order request using standard procedures followed by order fulfillment engine 122.

Control Engine 118 includes a delivery engine 160. Upon determining that the requested quantity exceeds the maximum quantity that is optimized for the target delivery date, delivery engine 160 uses delivery rules to calculate an extended delivery plan for fulfillment of the order request. The extended delivery plan includes at least one delivery for a target date that is later than the order request's target delivery date. The extended delivery plan can include partial orders, which can include a partial order for delivery of an amount of the item that does not exceed Qmax to be delivered by the target delivery date.

Control engine 118 further sends action signals to order fulfillment engine 122 to adjust an action for fulfilling the order request based on the extended delivery plan. Control engine 113 applies Qmax to its delivery rules, which can change an outcome of the delivery rules, which can cause a change to the delivery date. The delivery date is communicated as an action signal to order fulfillment engine 124 to take action to schedule a delivery accordingly.

The distribution center can offer many different kinds of items, such as thousands of different items. Orders can be received for items in great quantities from users accessing the online store's website, including at a rate that cannot be managed manually. Stocking and replenishment of the items can be provided by many DCs, such as tens or hundreds of DCs. Determination of the optimal maximum quantity for each item at the time of each order request is a complex determination that is beyond manual capability. Once it is determined that an order request for an item exceeds the maximum quantity for that item, adjustments to actions for fulfilling the order request are immediately put in place in accordance with an extended delivery plan to prevent the order request from being fulfilled by arranging to deliver an amount of stock of the item that would disrupt other orders, while maximizing utilization of stock of the item that is available, maximize servicing as many order requests as possible, and minimize the number and degree of customers that are impacted by the extended delivery plan.

Optimization of Qmax and implementation of extended delivery plans when Qmax is exceeded potentially reduces the amount of items that are back ordered and improves customer satisfaction, particularly for regular clients that submit order requests on a regular basis for a predictable amount of items, and avoids disruptions to such clients when an unexpected order request is received for a large amount of an item.

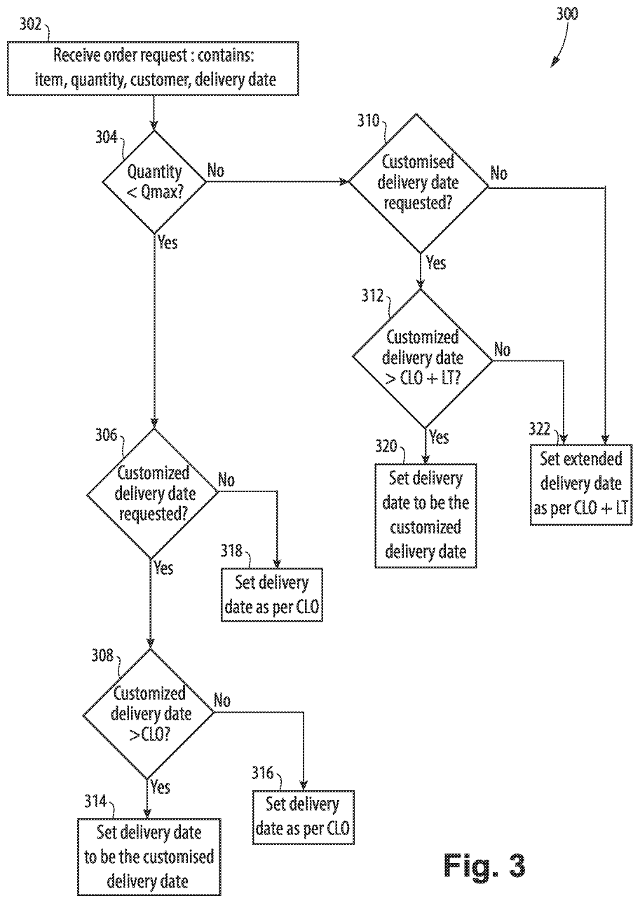

With reference now to FIGS. 2 and 3, shown are flowcharts demonstrating implementation of the methods used with various exemplary embodiments of online ordering system 100. It is noted that the order of operations shown in FIGS. 2 and 3 are not required, so in principle, the various operations may be performed out of the illustrated order. Also certain operations may be skipped, different operations may be added or substituted, some operations may be performed in parallel instead of strictly sequentially, or selected operations or groups of operations may be performed in a separate application following the embodiments described herein.

Language that refers to the transfer of information is not meant to be limiting. For example, the term “receive” as used herein refers to obtaining, getting, accessing, retrieving, reading, or getting a transmission. Use of any of these terms is not meant to exclude the other terms. Data that is transferred to or from a module or engine can be transferred by a transmission to or from the module or engine, or can include the data in a location that can be accessed by the module or engine or is provided in a manner to be accessible to another module or engine.

The method illustrated by flowchart 200 can be performed by an order fulfillment manager, such as order fulfillment manager 110 shown in FIG. 1. At block 202, historical order data is received for a distribution center, a customer, and an item over time. At block 204, historical stock data is received for the distribution center and the item over time. At block 206, future order data is simulated per customer for the distribution center and the item. At block 208, fulfillment of the simulated future order data is simulated based on the simulated future order data and corresponding historic stock data. At block 210, a maximum quantity of the item allowed to be ordered by the customer form the distribution center over time is optimized based on the simulated fulfillment.

At block 212, notification of an order request by the customer is received for a requested quantity of the item from the distribution center for a requested target delivery date. At block 214, it is determined whether the requested quantity exceeds the maximum quantity that is optimized for the customer, item, and distribution center for the requested target delivery date. At block 216, upon determining that the requested quantity exceeds the maximum quantity for the target delivery date, a delivery plan is calculated for fulfilling the order request using the prediction model. At block 218, an action is caused for fulfilling the order request based on the delivery plan.

The method illustrated by flowchart 300 can be performed by a control engine that determines whether to generate an extended delivery plan, such as delivery engine 160 of control engine 118 shown in FIG. 1.

At block 302, an order request is received for an item (e.g., a finished item). The order request identifies the customer that placed the request, the item, a requested quantity, and optionally a customized delivery date. If a customized delivery date is not requested in the order request, a customer logistic offer (CLO), which is a standard delivery date is assigned to be the delivery date. If the order request is accepted, the customized delivery date or the standard date as per the CLO become a committed date for delivery.

At block 304, a determination is made whether the requested quantity exceeds Qmax. If the determination at block 304 is YES, meaning the requested quantity does exceed Qmax, the method continues at block 306. If the determination at block 304 is NO, meaning the requested quantity does not exceed Qmax, the method continues at block 310.

At block 306, a determination is made whether a customized delivery date was requested. If the determination at block 306 is YES, meaning a customized delivery date was requested, the method continues at block 308. If the determination at block 306 is NO, meaning a customized delivery date was not requested, the method continues at block 318, the delivery is set to occur as per the CLO.

At block 308, a determination is made whether the customized delivery date is greater than the CLO. If the determination at block 308 is YES, meaning the customized delivery date is greater than (meaning after) the CLO, the method continues at block 314. At block 314, the delivery is set to occur by the customized delivery date. If the determination at block 308 is NO, meaning the customized delivery date is not greater than the CLO, the method continues at block 316. At block 316, the delivery is set to occur as per the CLO.

At block 310, a determination is made whether the customized delivery date was requested. If the determination at block 310 is YES, meaning a customized delivery date was requested, the method continues at block 312. If the determination at block 310 is NO, meaning a customized delivery date was not requested, the method continues at block 324. At block 324, an extended delivery date is set to occur as per the CLO extended by the lead time (LT) indicated for the item ordered. At block 312, a determination is made whether the customized delivery date is greater than the CLO summed with lead time (LT) (CLO+LT), wherein LT is a latency between initiation and completion of an order request. If the determination at block 308 is YES, meaning the customized delivery date is greater than (CLO+LT), the method continues at block 320 he delivery is set to occur by the customized delivery date. At block 320, if the determination at block 312 is NO, meaning the customized delivery date is not greater than (CLO+LT), the method continues at block 322. At block 322, an extended delivery date is set to occur as per the CLO extended by the (LT indicated for the item ordered.

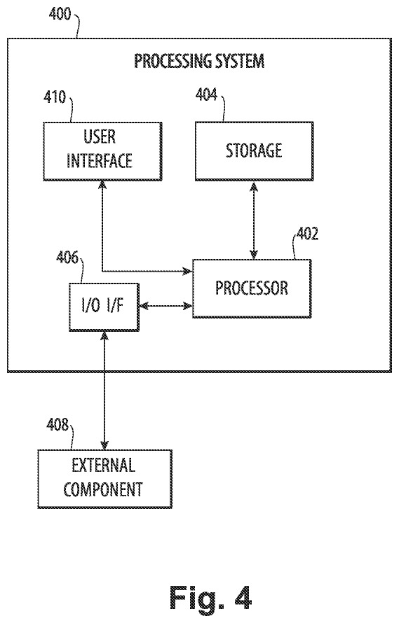

With reference to FIG. 4, a block diagram of an example computer system 400 is shown, which provides an example configuration of an order fulfillment manager 110, data collection system 130, and online server 120, each of which can be embodied, separately or in any combination, in one or more computer systems. One such computer system 400 is illustrated in FIG. 4. In various embodiments, computer system 400 may be a server, a mainframe computer system, a workstation, a network computer, a desktop computer, a laptop, a handheld computer, or the like, and/or include one or more of a field-programmable gate array (FPGA), application specific integrated circuit (ASIC), microcontroller, microprocessor, or the like. Computer system 400 is only one example of a suitable system and is not intended to suggest any limitation as to the scope of use or functionality of embodiments of the disclosure described herein. Computer system 400 can be implemented using hardware, software, and/or firmware. Regardless, processing system 400 is capable of being implemented and/or performing functionality as set forth in the disclosure.

Computer system 400 is shown in the form of a general-purpose computing device. Computer system 400 includes one or more processors 402, memory 404, an input/output (I/O) interface (I/F) 406 that can communicate with an internal component, such as a user interface 410, and optionally an external component 408.

Order fulfillment manager 110, data collection system 130, and/or online server 120 can be configured to handle large amounts of data. Computer system(s) used to implement order fulfillment manager 110, data collection system 130, and/or online server 120 and can be implemented, for example, using multiprocessors, a big data architecture, or one or more cloud-based computer systems.

The processor(s) 402 can include, for example, a single core or multicore processor, a programmable logic device (PLD), microprocessor, DSP, a microcontroller, an FPGA, an ASIC, and/or other discrete or integrated logic circuitry having similar processing capabilities.

The processor(s) 402 and the memory 404 can be included in components provided in the FPGA, ASIC, microcontroller, or microprocessor, for example. Memory 404 can include, for example, volatile and non-volatile memory for storing data temporarily or long term, and for storing programmable instructions executable by the processor(s) 402. Memory 404 can be a removable (e.g., portable) memory for storage of program instructions. I/O I/F 406 can include an interface and/or conductors to couple to the one or more internal components, such as user interface 410 and/or external components 408.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the block diagram block or blocks.

Embodiments of the processing components of geolocation prediction module 104 may be implemented or executed by one or more computer systems, such as a microprocessor. Each computer system 400 can be included within geolocation prediction module 104, or multiple instances thereof. In various embodiments, computer system 400 may include one or more of a microprocessor, an FPGA, application specific integrated circuit (ASIC), microcontroller. The computer system 400 can be provided as an embedded device. Portions of the computer system 400 can be provided externally, such by way of a virtual, centralized, and/or cloud-based computer.

Computer system 400 is only one example of a suitable system and is not intended to suggest any limitation as to the scope of use or functionality of embodiments of the disclosure described herein. Regardless, computer system 400 is capable of being implemented and/or performing any of the functionality set forth hereinabove.

Computer system 400 may be described in the general context of computer system-executable instructions, such as program modules, being executed by a computer system. Generally, program modules may include routines, programs, objects, components, logic, data structures, and so on that perform particular tasks or implement particular abstract data types.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

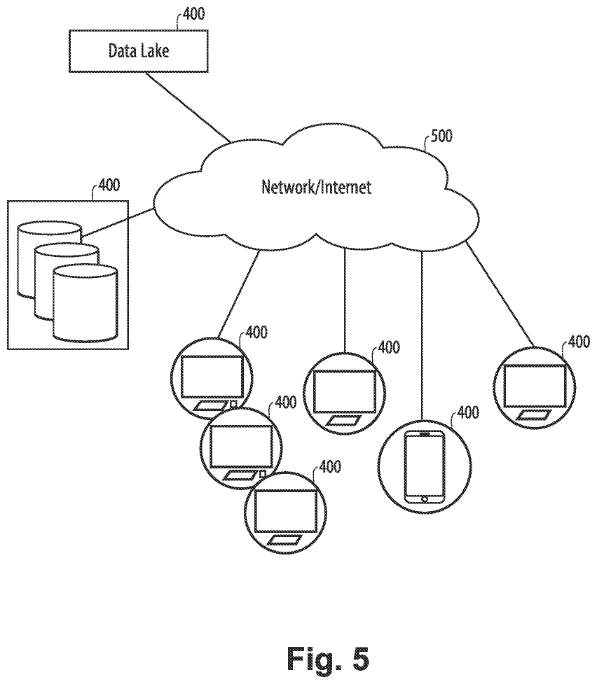

With reference to FIG. 5, computing devices 400 can operate in various environments and can be configured to communicate via one or more networks 500. Network 500 can include one or more networks, such as a LAN, WAN, and/or the Internet. Computing devices 400 can be configured to operate in environments that use multiprogramming that allows multiple threads in one or more processors for single procedures, multiprocessing for distributed, simultaneous processing of software programs and programmed operations, cloud computing using the Internet or other network(s) 500, and/or a big data architecture. The big data architecture, can include, for example, a data lake that receives data from multiple data sources. Orchestration can be provided that coordinates handling of the incoming data as well as analytics, batch processing, streaming data processing, storage, and/or machine learning.

An example determination of Qmax for an example scenario is now described to demonstrate an example application of the disclosed method. Regarding simulation of a starting inventory by simulator 112, TABLE 1 shows a stock movie for an item at a distribution center.

TABLE 1

| | | | | Current | | |
|---|---|---|---|---|---|---|
| | | | | Safety | Replenishment | # |
| | | | | Stock | point | weeks |
| site | Material | Stock | id_sq_period_year_week | (“CSS”) | (R.P.) | interval |
| DC1 | MATERIAL 1 | 24769 | 201911 | 10828 | | |
| DC1 | MATERIAL 1 | 24601 | 201912 | 10828 | | |
| DC1 | MATERIAL 1 | 16341 | 201913 | 10828 | | |
| DC1 | MATERIAL 1 | 16440 | 201914 | 10828 | R.P. | 2 |
| DC1 | MATERIAL 1 | 13967 | 201915 | 10828 | | |
| DC1 | MATERIAL 1 | 19227 | 201916 | 10828 | R.P. | 4* |
| DC1 | MATERIAL 1 | 17795 | 201917 | 10828 | | |
| DC1 | MATERIAL 1 | 17645 | 201918 | 10828 | | |
| DC1 | MATERIAL 1 | 17365 | 201919 | 8354 | | |
| DC1 | MATERIAL 1 | 19265 | 201920 | 8354 | R.P. | 1 |
| DC1 | MATERIAL 1 | 19928 | 201921 | 5004 | R.P. | 7* |
| DC1 | MATERIAL 1 | 14070 | 201922 | 5004 | | |
| DC1 | MATERIAL 1 | 11288 | 201923 | 5004 | | |
| DC1 | MATERIAL 1 | 8648 | 201924 | 5004 | | |
| DC1 | MATERIAL 1 | 8197 | 201925 | 5004 | | |
| DC1 | MATERIAL 1 | 4873 | 201926 | 5004 | | |
| DC1 | MATERIAL 1 | 1540 | 201927 | 5234 | | |
| DC1 | MATERIAL 1 | 5872 | 201928 | 5234 | R.P. | 1 |
| DC1 | MATERIAL 1 | 11672 | 201929 | 5234 | R.P. | 2 |
| DC1 | | | | | | |
| DC1 | MATERIAL 1 | 9173 | 201930 | 5234 | | |
| DC1 | | | | | | |
| DC1 | MATERIAL 1 | 12222 | 201931 | 5234 | R.P. | 5* |
| DC1 | | | | | | |
| DC1 | MATERIAL 1 | 12221 | 201932 | 5234 | | |
| DC1 | MATERIAL 1 | 9130 | 201933 | 5234 | | |
| DC1 | MATERIAL 1 | 8890 | 201934 | 5234 | | |
| DC1 | MATERIAL 1 | 8482 | 201935 | 5234 | | |
| DC1 | MATERIAL 1 | 13790 | 201936 | 2828 | R.P. | 2 |
| DC1 | MATERIAL 1 | 13790 | 201937 | 2828 | | |
| DC1 | MATERIAL 1 | 16805 | 201938 | 2828 | R.P. | 2 |
| DC1 | MATERIAL 1 | 12285 | 201939 | 2828 | | |
| DC1 | MATERIAL 1 | 16834 | 201940 | 2828 | R.P. | 2 |
| DC1 | MATERIAL 1 | 16834 | 201941 | 2828 | | |
| DC1 | MATERIAL 1 | 19984 | 201942 | 2828 | R.P. | 2 |
| DC1 | MATERIAL 1 | 19942 | 201943 | 5940 | | |
| DC1 | MATERIAL 1 | 21092 | 201944 | 5940 | R.P. | 1 |
| DC1 | MATERIAL 1 | 27171 | 201945 | 5940 | R.P. | 10* |
| DC1 | MATERIAL 1 | 25981 | 201946 | 5940 | | |
| DC1 | MATERIAL 1 | 21611 | 201947 | 5940 | | |
| DC1 | MATERIAL 1 | 19430 | 201948 | 5940 | | |
| DC1 | MATERIAL 1 | 19014 | 201949 | 5940 | | |
| DC1 | MATERIAL 1 | 12214 | 201950 | 5940 | | |
| DC1 | MATERIAL 1 | 9345 | 201951 | 5940 | | |
| DC1 | MATERIAL 1 | 2356 | 201952 | 6540 | | |
| DC1 | MATERIAL 1 | 2349 | 202001 | 6540 | | |
| DC1 | MATERIAL 1 | 2349 | 202002 | 6540 | | |
| DC1 | MATERIAL 1 | 4979 | 202003 | 6540 | R.P. | 1 |
| DC1 | MATERIAL 1 | 7609 | 202004 | 6540 | R.P. | |

In the stock movie, the replenishment points are identified. The intervals between two consecutive replenishment points with more than four weeks are marked with an “*” and are selected as a candidate interval for calculating the starting inventory.

Table 2 shows all the candidate intervals from TABLE 1 in tabulated form. Of note, the last row in TABLE 2 is for illustration only, and was not present in the actual stock movie. This row was added to illustrate the difference of stock movie ADU and an adjusted ADU.

TABLE 2

| | | | SOH Delta | | | | “Depleted | Stock | | | |
|---|---|---|---|---|---|---|---|---|---|---|---|
| | | SOH before | between 2 | Avg. | | | Qty” | Movie | | | |
| SOH at | | next | repl. | “Current” | | | supported | Repl. | | | Latest |
| replen- | | replen- | points | SS | SOH | | by “SOH | Interval | Adjusted | Master | “Current |
| ishment | no of | ishment | (“Depleted | during | wo SS | | w/o SS | ADU | ADU | ADU | Safety |
| point | week | point | Qty”) | interval | factor | Flag | factor” | (wd) | (wd) | (wd) | Stock” |
| 19227 | 4 | 17365 | 1862 | 10210 | 9017 | Y | 1862 | 93 | 93 | 411 | 6540 |
| 19928 | 7 | 1540 | 18388 | 5037 | 14891 | N | 13351 | 525 | 525 | 411 | 6540 |
| 12222 | 5 | 8482 | 3740 | 5234 | 6988 | Y | 3740 | 150 | 150 | 411 | 6540 |
| 27171 | 10 | 2349 | 24822 | 6120 | 21051 | N | 18702 | 496 | 496 | 411 | 6540 |
| 10000 | 4 | 0 | 10000 | 8000 | 2000 | N | 2000 | 500 | 427 | 411 | 6540 |

Key
Flag = if “depleted qty” can be fully supported by “SOH w/o SS factor”
SOH = Stock on Hand
SS = Safety Stock

In the example shown, the ADU was adjusted only if the prior SS (in this example average SS) was consumed during the interval to support a condition when “Depleted Qty” and the current SS is lower than the prior SS (in this example average SS). This condition implies that the “depleted qty” is unlikely to be fulfilled if the prior SS was at the current SS level. Hence the adjusted ADU is derived to be the maximum “Depleted Qty” that could have been supported under the condition that only this lower current SS was available during the concerned period.

In the example shown, the interval is selected in which the Adjusted ADU is between −5% of Master ADU and 20% of Master ADU. The starting inventory can be calculated, e.g., as a function of master ADU and master mean (or AVG) SS.

Regarding simulation of orders by bootstrapping engine 114, TABLES 3 and 4 show example demand data for a previous 12 month period per customer x, y and z for an item via a distribution center.

TABLE 3

| Customer | Demand in last 12 mo per customer (Master) | | | | | |
|---|---|---|---|---|---|---|
| X | 120 | 40 | 100 | 0 | 10 | 0 |
| Y | 20 | 50 | 60 | 90 | 0 | 0 |
| Z | 10 | 0 | 0 | 0 | 0 | 0 |
| Total | 150 | 90 | 160 | 90 | 10 | 0 |

TABLE 4

| | | | (Master) | |
|---|---|---|---|---|
| | ADU by | % by | ADU | (M) ADU |
| SUM | Customer | Customer | +10% | -10% |
| 270 | 1.071 | 54% | 1.1786 | 0.9643 |
| 220 | 0.873 | 44% | 0.9603 | 0.7857 |
| 10 | 0.040 | 2% | 0.0437 | 0.0357 |
| 500 | 1.984 | 100% | 2.1825 | 1.7857 |

Based on the data in TABLE 3 and TABLE 4, TABLE 5 shows a demand series for Customer x, which was generated using bootstrapping for 100 days (ten days are shown):

TABLE 5

| | | | | | | | | | | Count: | Sum: | |
|---|---|---|---|---|---|---|---|---|---|---|---|---|
| | | | | | | | | | | Days with | Demand | |
| | | | | | | | | | | demand | during | |
| Day 1 | Day 2 | Day 3 | Day 4 | Day 5 | Day 6 | Day 7 | Day 8 | Day 9 | Day 10 | (100 days) | period | ADU |
| 0 | 0 | 0 | 0 | 0 | 0 | 0 | 0 | 0 | 0 | 0 | 0 | 0.0 |
| 0 | 0 | 0 | 10 | 0 | 0 | 0 | 0 | 0 | 0 | 1 | 10 | 1.0 |
| 0 | 0 | 0 | 10 | 0 | 0 | 0 | 10 | 0 | 0 | 2 | 20 | 2.0 |
| 0 | 120 | 0 | 0 | 0 | 120 | 0 | 0 | 120 | 0 | 3 | 360 | 36.0 |
| 0 | 140 | 0 | 0 | 140 | 0 | 30 | 0 | 0 | 0 | 3 | 310 | 31.0 |
| 2 | 0 | 0 | 140 | 20 | 0 | 0 | 30 | 0 | 0 | 4 | 192 | 19.2 |
| 2 | 0 | 40 | 0 | 0 | 0 | 0 | 0 | 0 | 40 | 3 | 82 | 8.2 |
| 4 | 0 | 0 | 0 | 30 | 140 | 140 | 30 | 140 | 120 | 7 | 604 | 60.4 |

In this example, two levels of filtering of the simulated series are applied for determining the most appropriate simulation of the demand series.

| | Customer X | |
|---|---|---|
| Filter Level 1 | Demand Interval Range: | |
| | Based on Master DB 136: Days with demand out | 4 |
| | of 365 days | |
| | Proportionally to 100 days, Days with demand | 1.0958904 |
| | Consider Upper Limit (+20%) | 1.3150685 |
| | Consider Lower Limit (-20%) | 0.8767123 |
| Filter Level 2 | ADU Range: | |
| | Proportionally to (Master) ADU | 1.0714 |
| | Consider Upper Limit (+10%) | 1.1785714 |
| | Consider Lower Limit (-10%) | 0.9642857 |

Based on the above two filtering levels, the second row in TABLE 5 (shown in bold) is selected as the simulated scenario for Customer x.

With reference to determination of the Objective function and Qmax, TABLE 6 shows a simulated demand when the total ADU is more than the master ADU.

TABLE 6

| | | | | | | | | | | ADU by | | |
|---|---|---|---|---|---|---|---|---|---|---|---|---|
| Customer | Simulated Demand for 100 days (only 9 shown) | | | | | | | | | Customer | | |
| X | 120 | 40 | 100 | 0 | 10 | 0 | 50 | 0 | 0 | 1.26984 | ADU | 2.61905 |
| Y | 20 | 50 | 60 | 90 | 0 | 20 | 0 | 0 | 0 | 0.95238 | Master | 1.5 |
| Z | 10 | 0 | 0 | 0 | 0 | 40 | 0 | 50 | 0 | 0.39683 | ADU | |

As a result of the total ADU exceeding the master ADU, OHI is apt to be consumed more than was expected, which undesirably lowers the value of Qmax. To mitigate this, the simulated data is multiplied by a mitigation factor, e.g., (master ADU/ADU), as shown in TABLE 7:

TABLE 7

| | | | | | | | | | | ADU by | | |
|---|---|---|---|---|---|---|---|---|---|---|---|---|
| Customer | Simulated Demand for 100 days (only 9 shown) | | | | | | | | | Customer | | |
| X | 68.727 | 22.909 | 57.272 | 0 | 5.727 | 0 | 28.63 | 0 | 0 | 0.72727 | ADU | 1.5 |
| Y | 11.4545 | 28.636 | 34.3636 | 51.5455 | 0 | 11.4545 | 0 | 0 | 0 | 0.54545 | Master | 1.5 |
| Z | 5.72727 | 0 | 0 | 0 | 0 | 22.9091 | 0 | 28.6364 | 0 | 0.22727 | ADU | |

A demand series as treated by the mitigation factor is applied to a root finding algorithm with an objective function.

The root of the objective function can be Qmax, which can also be scaled up according to the mitigation factor. If there is no root, a selection factor (e.g., 1.5) is multiplied by the maximum demand point can be used for Qmax.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method, comprising:
simulating future stock data for an item supplied by a distribution center based on a comparison of a recent consumption pattern of stock relative to a consumption pattern of historical stock data;
simulating future order data of the item for the distribution center based on historical order data;
optimizing, based on the simulated future stock data and the simulated future order data, a maximum quantity of the item allowed to be fulfilled by the distribution center;
receiving notification of an order request by a customer for a requested quantity of the item supplied by a distribution center for a target delivery date;
determining whether the requested quantity exceeds the maximum quantity that is optimized for the target delivery date;
upon determining that the requested quantity exceeds the maximum quantity that is optimized for the target delivery date, calculating an extended delivery plan for fulfilling the order request using the simulated fulfillment, wherein the extended delivery plan includes at least one delivery performed based on an extended delivery timeframe that is in excess of a standard delivery timeframe used by default for order requests of the item that request a compliant quantity of the item that would not exceed the maximum quantity when optimized for the standard delivery timeframe; and
adjusting an action for fulfilling the order request based on the extended delivery plan.

2. The method of claim 1, wherein the comparison uses a consumption pattern associated with a selected portion of the historical stock data that corresponds to a first cycle defined between replenishment points that most closely resembles a second cycle of the recent consumption pattern.

3. The method of claim 2, wherein the consumption pattern associated with the selected portion of the historical stock data is based on average daily unit (ADU).

4. The method of claim 3, wherein the ADU is adjusted for usage of safety stock before selecting the selected portion of the historical stock data.

5. The method of claim 1, wherein simulating future order data comprises:
generating simulations of multiple ordering scenarios for respective customers associated with historical order data for the item; and
selecting a most probable scenario from the generated simulations of the multiple ordering scenarios based on a comparison of one or more parameters of stocking of the generated simulations to one or more calculated parameters of stocking for the item, historical changes in calculated parameters of stocking for the item, and/or trends in the calculated parameters of stocking for the item.

6. The method of claim 5, wherein the calculated parameters of stocking include at least one of average daily unit (ADU), average demand interval (ADI), and statistics related to safety stock.

7. The method of claim 5, wherein the generated simulations are generated using random sampling of the historical order data.

8. The method of claim 5, wherein the most probable scenario is selected using impact data about orders, wherein the impact data provides information about orders that were impacted by nonfulfillment of a complete order by a requested date as requested by the order request.

9. The method of claim 1, further comprising:
receiving the historical order data for the distribution center, the historical order data specifying a plurality of historical orders from a plurality of customers for the item over time; and
receiving the historical stock data for the item and the distribution center, the historical stock data specifying historical stock status and parameters of stocking and replenishing stock of the item over time.

10. The method of claim 9,
wherein the historical order data and the historical stock data received are continually updated, the method further comprising updating the simulation of the future order data and the optimization of the maximum quantity as the historical order data and the historical stock data is updated.

11. The method of claim 1, wherein optimizing the maximum quantity includes applying a root finding function and/or optimization technique.

12. The method of claim 9, wherein the historical stock status includes an amount of a respective items available in stock at intervals of time, the parameters of stocking include safety stock that indicates an amount of the respective items intended to be held in stock at all times that is not available for routine fulfillment of orders, average daily unit that indicates an amount of the items ordered for the respective items for a predetermined interval of time, and/or backorders for the respective items that indicates an amount of the respective items ordered while not currently available in stock and still available for order and/or the parameters of replenishing stock include a reorder point that indicates an amount of available stock of the respective items at which the stock needs to be replenished for the respective items, a lead time that indicates latency between receipt of an order request for and delivery of the respective items, and/or respective items in transit that identifies an amount of the respective items that are in transit for replenishing stock of the respective items.

13. The method of claim 9, wherein the parameters of replenishing stock include parameters of replenishing stock for respective distribution centers of a plurality of distribution centers and for respective items of a plurality of items, and wherein generating the simulation of the fulfillment applies methods of processing big data.

14. A computing system comprising:
a memory configured to store a plurality of programmable instructions; and
a processing device in communication with the memory, wherein the processing device, upon execution of the plurality of programmable instructions is configured to:
simulate future stock data for an item supplied by a distribution center based on a comparison of a recent consumption pattern of stock relative to a consumption pattern of historical stock data;
simulate future order data of the item for the distribution center based on historical order data;
optimize, based on the simulated future stock data and the simulated future order data, a maximum quantity of the item allowed to be fulfilled by the distribution center;
receive notification of an order request by a customer for a requested quantity of the item supplied by a distribution center for a target delivery date;
determine whether the requested quantity exceeds the maximum quantity that is optimized for the target delivery date;
upon determining that the requested quantity exceeds the maximum quantity that is optimized for the target delivery date, calculate an extended delivery plan for fulfilling the order request using the simulated fulfillment, wherein the extended delivery plan includes at least one delivery performed based on an extended delivery timeframe that is in excess of a standard delivery timeframe used by default for order requests of the item that request a compliant quantity of the item that would not exceed the maximum quantity when optimized for the standard delivery timeframe; and
adjust an action for fulfilling the order request based on the extended delivery plan.

15. The computing system claim 14, wherein the comparison uses a consumption pattern associated with a selected portion of the historical stock data that corresponds to a first cycle defined between replenishment points that most closely resembles a second cycle of the recent consumption pattern.

16. The computing system claim 15, wherein the consumption pattern associated with the selected portion of the historical stock data is based on average daily unit (ADU).

17. The computing system claim 16, wherein the ADU is adjusted for usage of safety stock before selecting the selected portion of the historical stock data.

18. The computing system claim 14, wherein simulating future order data comprises:
generating simulations of multiple ordering scenarios for respective customers associated with historical order data for the item; and
selecting a most probable scenario from the generated simulations of the multiple ordering scenarios based on a comparison of one or more parameters of stocking of the generated simulations to one or more calculated parameters of stocking for the item, historical changes in calculated parameters of stocking for the item, and/or trends in the calculated parameters of stocking for the item.

19. The computing system claim 18, wherein the calculated parameters of stocking are include at least one of average daily unit (ADU), average demand interval (ADI), and statistics related to safety stock.

20. The computing system claim 18, wherein the generated simulations are generated using random sampling of the historical order data.
